(19) United States
(12) Patent Application Publication
(10) Pub. No.: US 2015/0368082 A1
(43) Pub. Date: Dec. 24, 2015

(54) COLLISION AVOIDANCE SYSTEM FOR SCISSOR LIFT

(71) Applicant: The Boeing Company, Chicago, IL (US)

(72) Inventors: Gordon D. Davis, Marysville, WA (US); Gary M. Buckus, Bothell, WA (US); Farshad Forouhar, Lake Forest Park, WA (US); Vincent E. Engdahl, Everett, WA (US); Curtis N. Sovereen, Everett, WA (US)

(21) Appl. No.: 14/312,607

(22) Filed: Jun. 23, 2014

(51) Int. Cl. B66F 17/00; B66F 11/04

(52) U.S. Cl. CPC B66F 17/006; B66F 11/042

(57) ABSTRACT

Disclosed is a collision avoidance method, controller, and system for a scissor lift. The scissor lift includes a passenger basket, a scissor extension mechanism, and a base with wheels. The collision avoidance system includes at least one of a basket proximity sensor sub-system that has proximity sensor elements disposed on the passenger basket. The collision avoidance system also includes a basket contact sensor sub-system that has impact sensor elements disposed within padded bumpers coupled to the passenger basket and a through-beam sensor sub-system mounted to the scissor extension mechanism. Still further, the collision avoidance system includes a wheel position transducer that is coupled to at least one of the wheels of the base.

### FIELD

This disclosure relates generally to sensor systems, and more particularly to collision avoidance systems for scissor lifts.

### BACKGROUND

Scissor lifts are often operated by lift operators, who are supported in a passenger basket of the scissor lift, into desired positions to allow the operators to accomplish a task or manage a repair on an elevated structure. For example, scissor lifts are used during the inspection, maintenance, and repair of aircraft. Operators generally drive the scissor lift into a desired position alongside a section of an aircraft (or other structure to be inspected or repaired). Once in position near the aircraft structure, the operator elevates the passenger basket to a desired height in order to perform the desired task on the structure.

However, while performing the inspection or repair on the structure, the operator may need to repeatedly adjust the vertical position of the passenger basket and/or repeatedly adjust the horizontal position of the passenger basket by driving the scissor lift to a new location near the structure. These position and location adjustments can result in the operator inadvertently maneuvering the scissor lift into contact with the structure (or into contact with another surrounding object).

Such collisions not only have the potential to cause aesthetic and structural damage to the structure, but may also damage the scissor lift itself. For example, the passenger basket of the scissor lift may collide with the wing of an aircraft, potentially causing substantial damage to the aircraft and requiring an extensive and costly repair. In another example, an object may inadvertently get caught in the scissor extension mechanism, thus damaging the obstructing object and damaging the scissor extension mechanism. Further, the operator may accidentally drive the scissor lift into contact with a structure because the operator did not know and could not see the position (i.e., direction) of the wheels upon moving the lift.

While certain conventional control systems endeavor to prevent scissor lift collisions, such systems are usually difficult to implement, difficult to use, and often cost the operator more time and money than saved.

### SUMMARY

The subject matter of the present application has been developed in response to the present state of the art, and in particular, in response to shortcomings of conventional scissor lift systems. The subject matter of the present application has been developed to provide a system and method that overcome at least some of the above-discussed shortcomings of prior art techniques.

According to one embodiment, a method for avoiding collisions between a scissor lift and surrounding objects is disclosed. The method includes detecting at least one of a spatial proximity of the passenger basket with respect to the surrounding objects, an impact condition of the passenger basket with respect to the surrounding objects, an obstruction condition of the scissor extension mechanism with respect to the surrounding objects, and a wheel position of at least one of the wheels of the base. The method also includes determining a collision status based on at least one of the spatial proximity, the impact condition, the obstruction condition, and the wheel position. The method further includes activating a warning indicator when the collision status is within a predetermined warning threshold, and over-riding operator control of the scissor lift when the collision status is within a predetermined over-ride threshold.

In one implementation of the method, detecting the spatial proximity of the passenger basket with respect to the surrounding objects is based on input from a plurality of proximity sensor elements disposed on at least one face of the passenger basket. In yet some implementations, detecting the spatial proximity of the passenger basket with respect to the surrounding objects is based on input from only proximity sensor elements disposed on faces of the passenger basket approaching surrounding objects.

According to another embodiment, a controller apparatus for a scissor lift is described. The scissor lift includes a passenger basket, a scissor extension mechanism, and a base with wheels. The controller apparatus includes at least one of a sensing module, a collision module, a warning module, and an over-ride module. The sensing module includes, according to one embodiment, a basket proximity sub-module that detects a spatial proximity of the passenger basket to surrounding objects. The sensing module may further include a basket contact sub-module that detects an impact condition of the passenger basket with the surrounding objects, a scissor sub-module that detects an obstruction condition of the scissor extension mechanism with the surrounding objects, and a wheel sub-module that detects a wheel position of at least one of the wheels of the base.

The collision module determines a collision status based on the spatial proximity, the impact condition, the obstruction condition, and the wheel position detected by the sensing module. The warning module activates a warning indicator when the collision status is within a predetermined warning threshold and the over-ride module over-rides operator control of the scissor lift when the collision status is within a predetermined over-ride threshold.

In one implementation of the controller apparatus, the collision module determines the collision status based on a distance between the passenger basket and the nearest surrounding object. For example, the predetermined warning threshold may be less than about 5 feet and the warning indicators may include one or more of visible alarms and audible alarms. Further, the warning module may include multiple warning thresholds that correspond with multiple warning indicators. In one example, the collision module determines the collision status based on an actual collision. Further, in one implementation the controller apparatus further includes a display module that displays one or more of the spatial proximity, the impact condition, the obstruction condition, the wheel position, the collision status, the warning indicator, the warning threshold, and the over-ride threshold.

According to yet another embodiment, a collision avoidance system for a scissor lift is disclosed. The scissor lift includes a passenger basket, a scissor extension mechanism, and a base with wheels. The collision avoidance system includes a basket proximity sensor sub-system that has proximity sensor elements disposed on the passenger basket. The collision avoidance system also includes a basket contact sensor sub-system that has impact sensor elements disposed within padded bumpers coupled to the passenger basket.

In one implementation of the system, the proximity sensor elements are non-contact sensors, such as ultrasonic sensors. The passenger basket may include a front face, two side faces, a rear face, a top face, and a bottom face. The proximity sensor elements of the basket proximity sensor sub-system may be disposed on the front face, the two side faces, the top face, rear face, and the bottom face. In one implementation, the proximity sensor elements that are disposed on the two side faces are positioned midway between the front and rear faces. The passenger basket may further include an extendable platform that has proximity sensor elements disposed thereon.

In another implementation of the system, the padded bumpers are coupled to the passenger basket along edges of the passenger basket and the impact sensor elements are omni-directional type sensors.

In one implementation of the system, the system further includes a through-beam sensor sub-system mounted to the scissor extension mechanism. The scissor extension mechanism has a basket-end portion and a base-end portion. The through-beam sensor sub-system has at least one corresponding set of an emitter and a receiver, with each emitter and receiver attached to one or the other of the basket-end portion and the base-end portion. Still further, the collision avoidance system may include a wheel position transducer that is coupled to at least one of the wheels of the base.

According to yet another embodiment, a collision avoidance system for a scissor lift is disclosed. The scissor lift includes a passenger basket, a scissor extension mechanism, and a base with wheels. The collision avoidance system includes a through-beam sensor sub-system mounted to the scissor extension mechanism. The scissor extension mechanism has a basket-end portion and a base-end portion. The through-beam sensor sub-system has at least one corresponding set of an emitter and a receiver, with each emitter and receiver attached to one or the other of the basket-end portion and the base-end portion. Still further, the collision avoidance system may include a wheel position transducer that is coupled to at least one of the wheels of the base.

In one implementation, the at least one corresponding set of the emitter and the receiver of the through-beam sensor sub-system utilizes infrared light. The scissor extension mechanism has exterior nodes so that the at least one corresponding set of the emitter and the receiver are moveable with the exterior nodes and move with the basket-end portion and the base-end portion of the scissor extension mechanism. In one specific implementation, the through-beam sensor sub-system includes three corresponding sets of the emitter and the receiver that substantially form a sensor curtain.

According to yet another embodiment, a collision avoidance system for a scissor lift is disclosed. The scissor lift includes a passenger basket, a scissor extension mechanism, and a base with wheels. The collision avoidance system includes a wheel position transducer that detects a wheel position of at least one of the wheels of the base.

In one implementation, the collision avoidance system further includes a collision module that determines a collision status based on the wheel position detected by the wheel position transducer, a warning module that activates a warning indicator when the collision status is within a predetermined warning threshold, and an over-ride module that over-rides operator control of the scissor lift when the collision status is within a predetermined over-ride threshold.

The described features, structures, advantages, and/or characteristics of the subject matter of the present disclosure may be combined in any suitable manner in one or more embodiments and/or implementations. In the following description, numerous specific details are provided to impart a thorough understanding of embodiments of the subject matter of the present disclosure. One skilled in the relevant art will recognize that the subject matter of the present disclosure may be practiced without one or more of the specific features, details, components, materials, and/or methods of a particular embodiment or implementation. In other instances, additional features and advantages may be recognized in certain embodiments and/or implementations that may not be present in all embodiments or implementations. Further, in some instances, well-known structures, materials, or operations are not shown or described in detail to avoid obscuring aspects of the subject matter of the present disclosure. The features and advantages of the subject matter of the present disclosure will become more fully apparent from the following description and appended claims, or may be learned by the practice of the subject matter as set forth hereinafter.

### BRIEF DESCRIPTION OF THE DRAWINGS

In order that the advantages of the subject matter may be more readily understood, a more particular description of the subject matter briefly described above will be rendered by reference to specific embodiments that are illustrated in the appended drawings. Understanding that these drawings depict only typical embodiments of the subject matter, they are not therefore to be considered to be limiting of its scope. The subject matter will be described and explained with additional specificity and detail through the use of the drawings, in which:

FIG. 1 is a perspective view of a scissor lift showing one embodiment of a collision avoidance system;

FIG. 2 is a front view of a scissor lift showing one embodiment of a collision avoidance system, specifically showing details of a basket proximity sensor sub-system and a basket contact sensor sub-system;

FIG. 3 is a front perspective view of a scissor lift showing one embodiment of a collision avoidance system, specifically showing details of a through-beam sensor sub-system;

FIG. 4 is a side view of a scissor lift showing one embodiment of a collision avoidance system, specifically showing additional details of a through-beam sensor sub-system;

FIG. 5A is a front view of a wheeled-base of a scissor lift according to one embodiment, specifically showing details of a wheel position transducer in a straight position;

FIG. 5B is a front view of a wheeled-base of a scissor lift according to one embodiment, specifically showing details of a wheel position transducer in a turned position;

FIG. 5C is a front view of a wheeled-base of a scissor lift according to one embodiment, specifically showing details of a wheel position transducer in another turned position;

FIG. 5D is a top view of the scissor lift showing one embodiment of a display unit for displaying operation and collision conditions;

FIG. 6A is schematic block diagram of one embodiment of a controller for avoiding scissor lift collisions;

FIG. 6B is a schematic block diagram of another embodiment of a controller for avoiding scissor lift collisions; and

FIG. 7 is a schematic flowchart diagram of one embodiment of a method for avoiding scissor lift collisions.

### DETAILED DESCRIPTION

Reference throughout this specification to “one embodiment,” “an embodiment,” or similar language means that a particular feature, structure, or characteristic described in connection with the embodiment is included in at least one embodiment of the present disclosure. Appearances of the phrases “in one embodiment,” “in an embodiment,” and similar language throughout this specification may, but do not necessarily, all refer to the same embodiment. Similarly, the use of the term “implementation” means an implementation having a particular feature, structure, or characteristic described in connection with one or more embodiments of the present disclosure, however, absent an express correlation to indicate otherwise, an implementation may be associated with one or more embodiments.

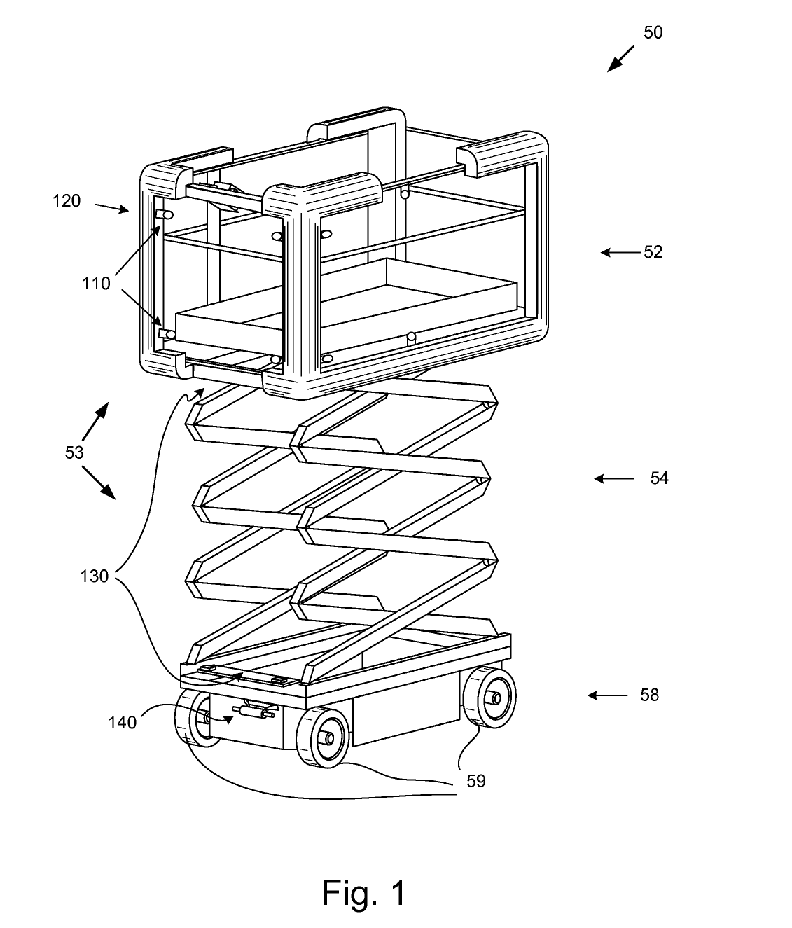

FIG. 1 is a perspective view of a scissor lift 50 showing one embodiment of a collision avoidance system 53. The scissor lift 50 includes a passenger basket 52 for holding and supporting passengers, operators, and equipment. The passenger basket 52 may be configured and sized according to the specifics of a given application. According to one embodiment, the passenger basket 52 is a rectangular box that has six faces: a front face, two side faces, a rear face, a top face, and a bottom face. The faces of the passenger basket 52 in the illustrated embodiment may be formed by intersecting bars and supports, and may not be a solid planar piece of material. In other embodiments, the faces of the passenger basket 52 may be solid panels of plastic, metal, wood, etc. The passenger basket 52 also includes a user control interface, enabling one or more operators/passengers to control the operation of the scissor lift. The user control interface may include buttons, switches, levers, joysticks, a steering wheel, a throttle, a touchscreen, a keypad, a keyboard, number-pads, etc.

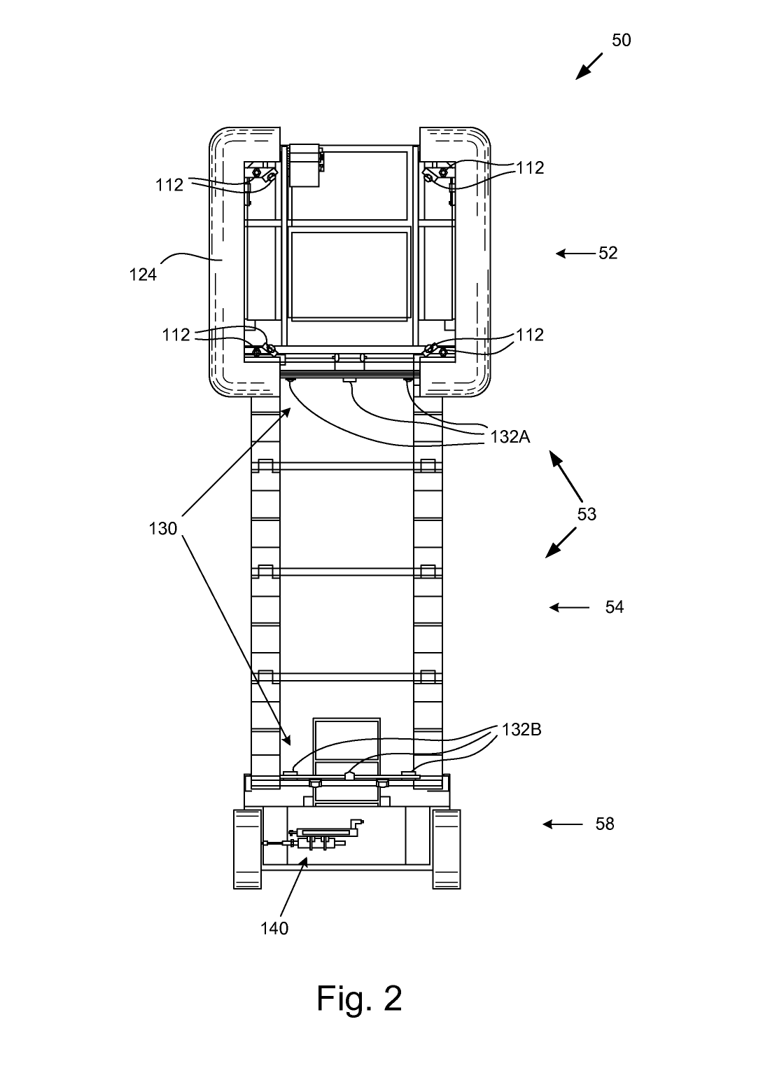

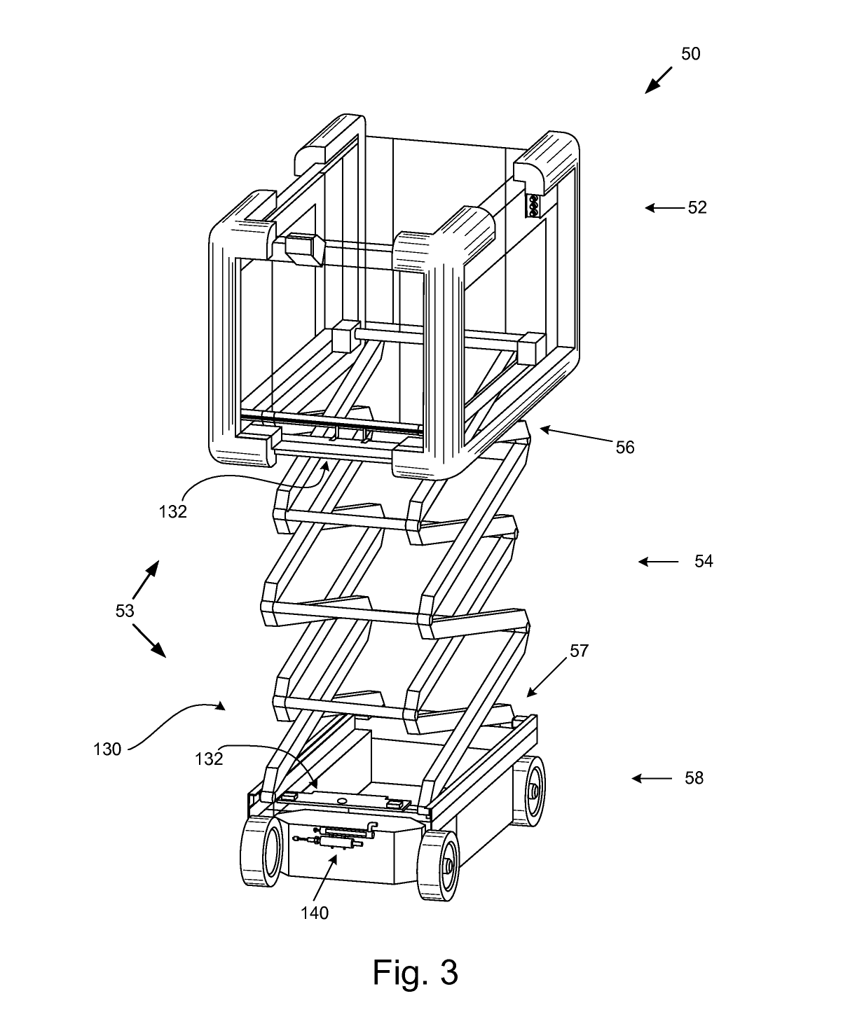

The scissor lift 50 further includes a scissor extension mechanism 54. The scissor extension mechanism 54 has includes a plurality support members hingedly coupled together in a pantographic structure. The pantographic structure allows the interconnected support members to extend and retract, thus permitting a user to correspondingly raise and lower the passenger basket 52. In one embodiment, as depicted, the scissor extension mechanism 54 includes two aligned pantographic structures. However, the scissor extension mechanism 54 of the scissor lift 50 may be employed with a single pantograph structure. In yet another embodiment, the scissor extension mechanism may have three or more pantograph structures, according to the specifics of a given application. Also, as seen in FIGS. 2 and 3, the scissor extension mechanism 54 may have lateral supports that extend between the pantographic structures to maintain inter-alignment.

The scissor lift 50 further includes a base 58 with wheels 59. The base 58 may house the power supply for operating the lift. For example, the base 58 may house an engine or an electrical energy source, such as a battery assembly or system of capacitors, for powering the lift 50. In another embodiment, the base 58 may include a hydraulic or pneumatic sub-system for driving the lift 50, and extending and retracting the scissor extension mechanism 54. As described above, these power systems may be controlled and managed from a user control interface in the passenger basket. Alternatively or additionally, the lift may include a user control interface at the base 58 to allow the scissor lift to be controlled from the ground. Although not described herein, other details and embodiments relating to a scissor lift, as recognized by those of ordinary skill in the art, fall within the scope of the present disclosure.

The collision avoidance system 53, according to one embodiment, includes a basket proximity sensor sub-system 110, a basket contact sensor sub-system 120, a through-beam sensor sub-system 130, and a wheel position transducer 140. Each of the control systems are described in greater detail below with reference to the remaining figures. Although the remaining figures generally depict and include all of the sub-systems 110, 120, 130, and wheel position transducer 140, it is expected that less than all of the sub-systems 110, 120, 130, 140 may be implemented in one embodiment, according to the specifics of a given application. For example, in one embodiment the basket proximity sensor sub-system 110 and the basket contact sensor sub-system may be implemented on a lift while the other sub-systems 130, 140 may be left off. In another embodiment, the basket proximity sensor sub-system 110 may be implemented as a stand-alone collision avoidance system. In other words, the implementation details and the inclusion of the sub-systems 110, 120, 130, 140 may be application specific and it is expected that those with ordinary skill in the art will recognize that these implementation variations fall within the scope of the present disclosure.

FIG. 2 is a front view of a scissor lift 50 showing one embodiment of a collision avoidance system 53, and specifically showing details of a basket proximity sensor sub-system 110 and a basket contact sensor sub-system 120. The proximity sensor sub-system 110 includes multiple proximity sensor elements 112. The proximity sensor elements 112 detect the distance between a surrounding object (i.e., a structure, an aircraft section, etc.) and the passenger basket 52. The proximity sensor elements 112, according to one embodiment, are non-contact sensor elements, such as ultrasonic sensors. Ultrasonic sensors, for example, emit an ultrasonic sound wave and receive reflected sound waves, and calculate the time for the sound wave to reflect back to the sensor, thereby determining the distance between a surrounding object and the passenger basket 52.

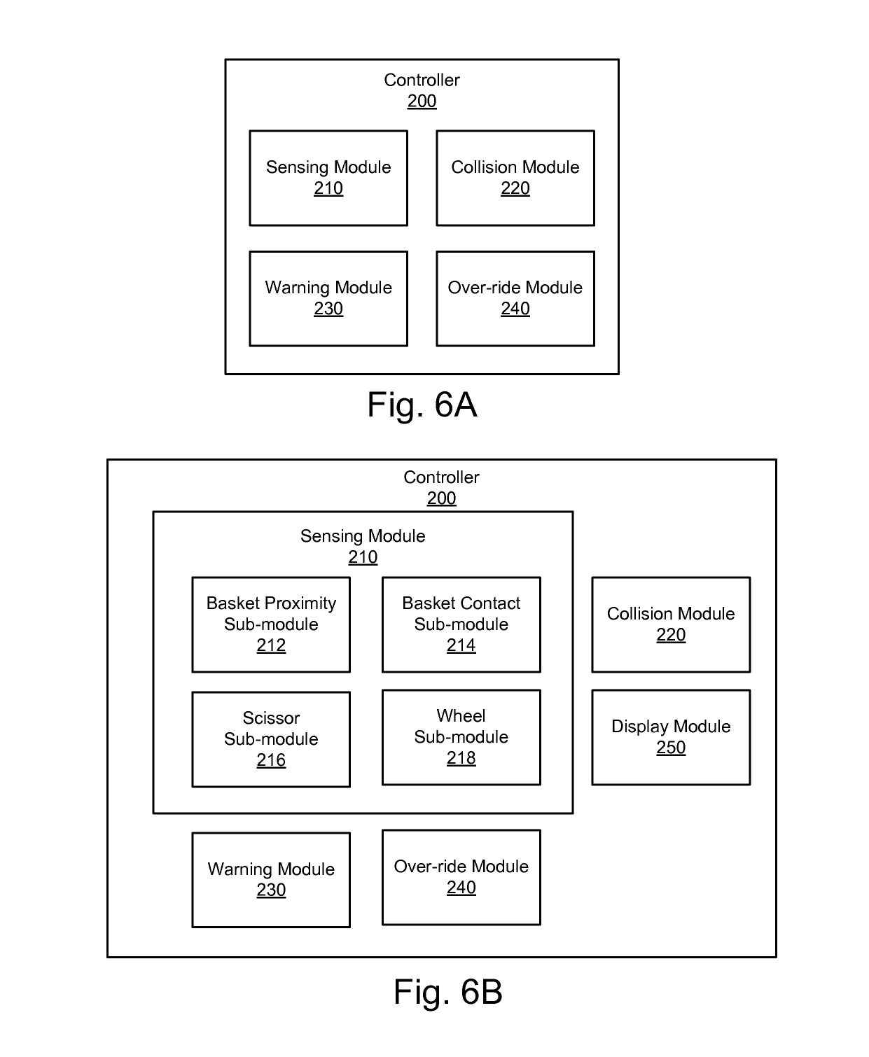

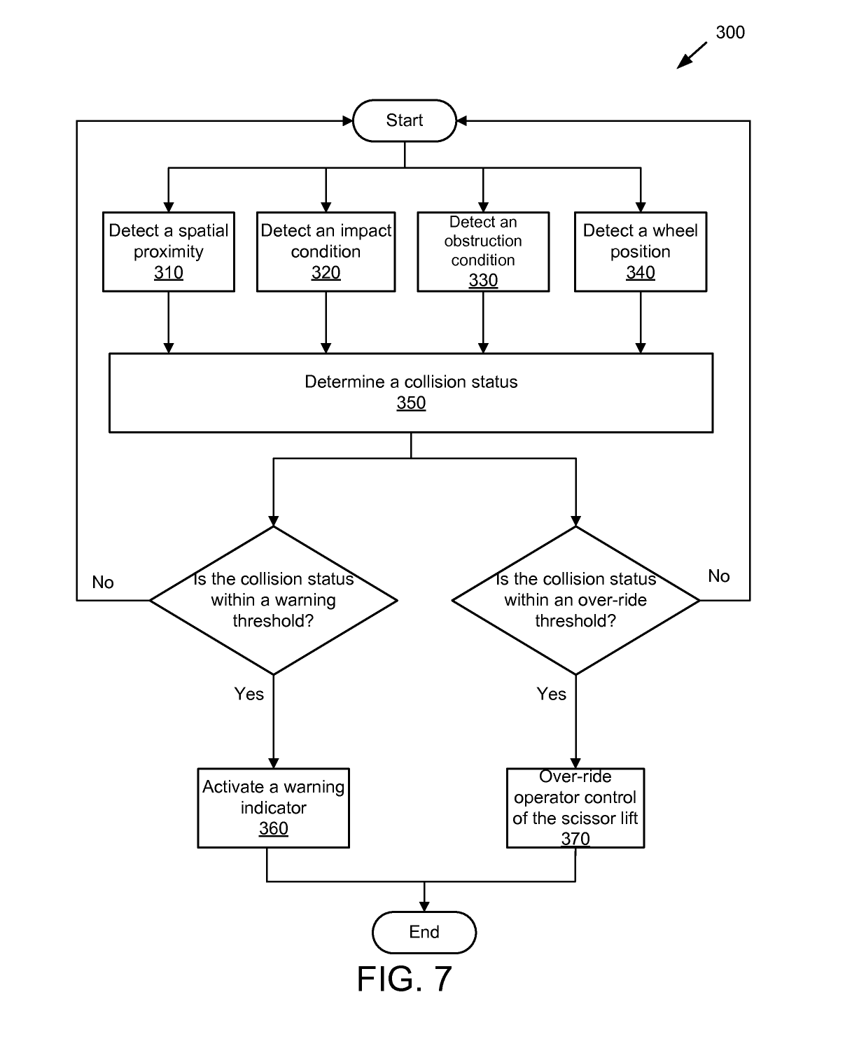

The proximity sensor elements 112 are disposed on the faces and/or edges of the passenger basket 52. As depicted in FIG. 2, the front face of the passenger basket 52 has multiple proximity sensor elements 112 mounted thereto. The number, spatial configuration, direction, and pattern of the proximity sensor elements 112 may be selected according to a specific application. For example, the front face of the passenger basket 52 may have comparatively more proximity sensor elements 112 (e.g., eight) than other faces of the passenger basket 52. In one embodiment, each and every face of the passenger basket 52 does not have proximity sensor elements 112. For example, the rear face of the passenger basket 52 may not need sensor elements 112 (or may only need one or two) because the scissor lift is not expected to back-up (i.e., move in reverse). Additional details relating to the use and control of the basket proximity sensor sub-system 110 are included below with reference to FIGS. 6A-7.

The basket impact sensor sub-system 120 includes padded bumpers 124 and impact sensor elements embedded within the padded bumpers 124. The padded bumpers 124 may be constructed of various materials and may have a cushioning/foam layer and/or a protective layer that prevents, or at least mitigates, the damage that would result if a collision were to occur. The padded bumpers 124 may be replaceable and/or easily mountable to the passenger basket 52. In one embodiment, the padded bumpers 124 may be coupled to the edges and railings of the passenger basket 52 while in other embodiments the padded bumpers 124 may be coupled to the face(s) of the passenger basket 52.

The impact sensor elements, according to one embodiment, are omni-directional sensors that not only detect the occurrence of an impact/collision, but also may provide information regarding the directional force of the impact. In such an embodiment, an operator, upon being alerted about a collision, may be able to prevent further damage to the impacted object/structure by knowing the direction that he/she needs to move the scissor lift 50 to pull back from the impacted object. In other words, the basket impact sensor sub-system 120 functions as a fail-safe/last resort in the collision avoidance system 53. For example, the padded bumpers 124 mitigate collision damage and the embedded contact sensor elements (not shown in the figures) alert the operator of the collision. Once again, additional details relating to the use and control of the basket contact sensor sub-system 120 are included below with reference to FIGS. 6A-7.

FIG. 3 is a front perspective view of the scissor lift 50 showing one embodiment of the collision avoidance system 53, and specifically showing details of the through-beam sensor sub-system 130. The proximity sensor elements 112 of the basket proximity sensor sub-system 110 are not depicted in FIG. 3. As stated previously, while the various sub-systems may be implemented individually or in various combinations, it is expected that, at least in one particularly useful embodiment, all of the collision avoidance sub-systems are implemented at the same time on the same scissor lift 50.

The through-beam sensor sub-system 130 includes at least one corresponding set 132 of an emitter and a receiver. The through-beam sensor sub-system 130 is configured to monitor and detect the presence of obstructions interfering with (i.e., contacting or impacting) the scissor extension mechanism 54 of the scissor lift 50. The emitter emits a substantially continuous signal (i.e., light beam, infrared, laser, etc.) that is received by the receiver. If an object interrupts the through-beam maintained between the emitter and receiver, the sensor sub-system would detect the obstruction and issue and alert/alarm and halts the scissor lift from future movement in the direction of imminent impact. Once again, additional details regarding the method, control, and alerts of the sub-systems are included below with reference to FIGS. 6A-7.

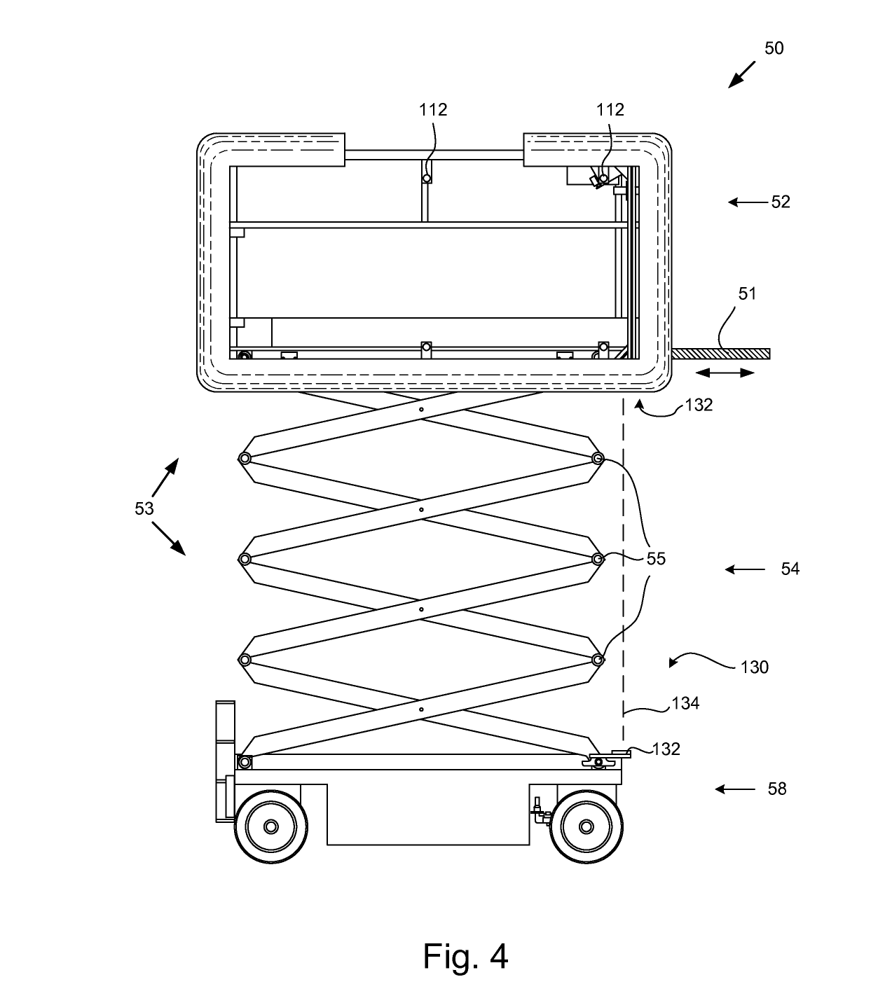

The scissor extension mechanism 54 has a basket-end portion 56 and a base-end portion 57. The basket-end portion 56 is the section/end of the scissor extension mechanism 54 that is coupled to the passenger basket 52 and the base-end portion 57 is the section/end of the scissor extension mechanism 54 that is coupled to the base 58 of the scissor lift 50. In each corresponding set 132 of emitter and receiver, one of the emitter and the receiver is mounted to the basket-end portion 56 of the scissor extension mechanism 54, while the other of the emitter and the receiver is mounted to the base-end portion 57 of the scissor extension mechanism 54. As described below with reference to FIG. 4, the emitter and receiver move with the scissor extension mechanism 54

In one embodiment, the through-beam sensor sub-system 130 may have multiple sets of emitters and receivers. Additionally, the sets 132 of emitters and receivers may be arranged in multiple banks that are positioned around the peripheral sides of the scissor extension mechanism. For example, although FIG. 3 only depicts a corresponding set 132 of an emitter and a receiver on the front of the scissor lift 50, it is possible for other sets 132 of receivers and emitters to be positioned along the sides and/or rear of the scissor lift 50. Returning to FIG. 2, the through-beam sensor sub-system 130 may include three emitters 132A and three receivers 132B that form sensor banks. The beams maintained between the emitters 132A and receivers 132B form a through-beam curtain.

FIG. 4 is a side view of the scissor lift 50 showing one embodiment of the collision avoidance system 53, and specifically showing additional details of the through-beam sensor sub-system 130. A representation of the beam 134 maintained between the corresponding set 132 of emitter and receiver is shown as a dashed line in FIG. 4. FIG. 4 also depicts various exterior nodes 55 of the scissor extension mechanism 54. As briefly mentioned above, each corresponding set 132 of emitter and receiver is mounted to and moves with the basket-end portion 56 and the base-end portion 57 of the scissor extension mechanism 54, respectively. Because sets 132 of emitters and receivers are mounted to the moving ends of the scissor extension mechanism 54, the extension and retraction of the scissor extension mechanism 54, which causes the body of pantographic structure(s) to narrow (during vertical extension) and widen (during vertical retraction), also causes the mounted emitters and receivers to move correspondingly (in the horizontally narrowing and widening directions). In other words, the beam 134 between the emitter and receiver is maintained just beyond the exterior nodes 55 of the scissor extension mechanism 54 to prevent the scissor extension mechanism 54 itself from registering as an obstruction by interrupting the through-beam 134.

FIG. 4 also depicts an extendable platform 51. In certain embodiments and in certain applications, the scissor lift 50 includes an extendable platform 51 that can extend out from the passenger basket 52 to allow operators/passengers greater positioning flexibility. In such embodiments, the platform 51 may also be configured to have additional proximity sensor elements 112 and/or impact sensor elements embedded in additional padding mounted to the platform.

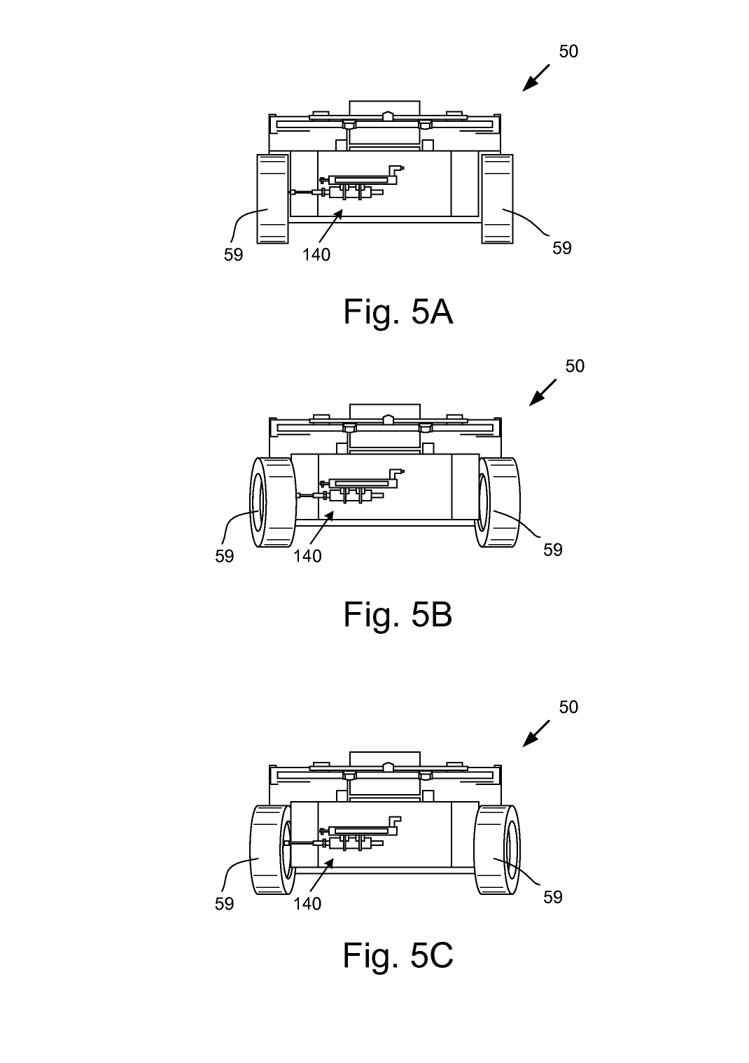

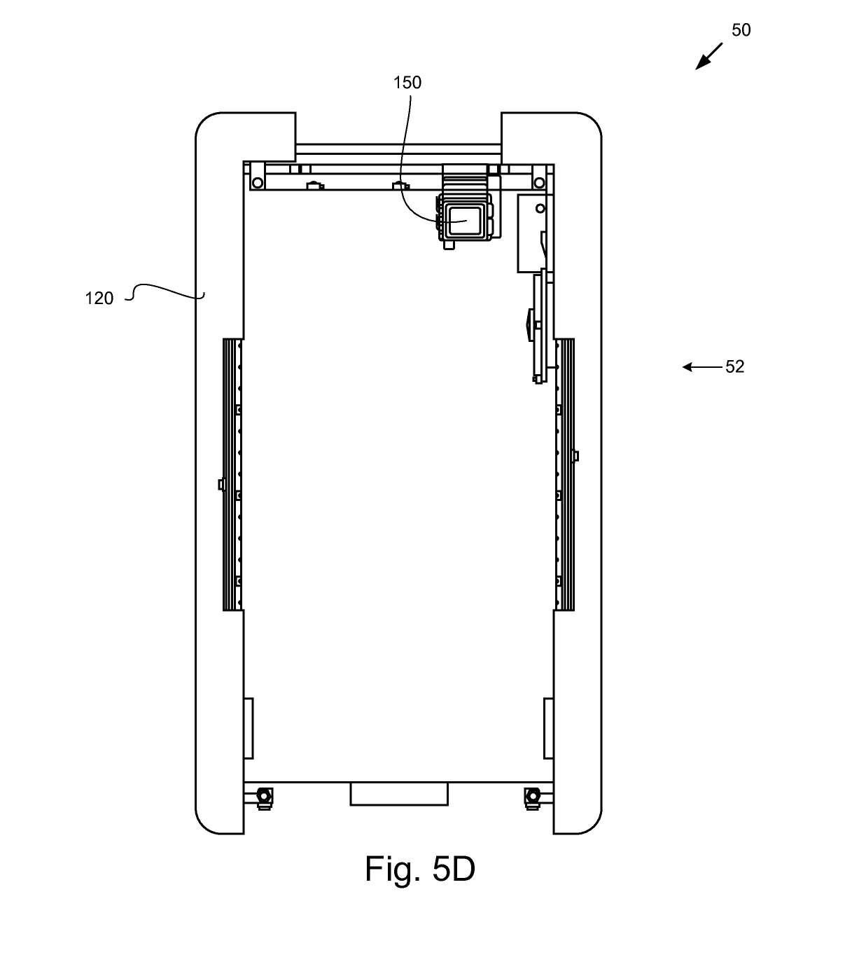

FIGS. 5A-5C are front views of a wheeled-base 58 of a scissor lift 50, specifically showing details of a wheel position transducer 140. In FIG. 5A, the wheels 59 of the base 58 are substantially straight, in FIG. 5B the wheels 59 of the base 58 are turned in a first direction, and in FIG. 5C the wheels 59 of the base 58 are turned in a second direction. The wheel position transducer 140 is configured to detect the wheel position and alert the operator, thereby making it easier for the operator/driver to move the lift 50 with confidence that he/she will not inadvertently run into an object. In other words, the operator does not have to try and remember, upon parking the lift 50, in which direction the wheels are oriented. The wheel position transducer 140 will detect such a position and report it back to the operator. In one embodiment, the wheel position transducer 140 only monitors a single wheel. In another embodiment, the wheel position transducer 140 monitors the positions of all the wheels (at least all of the “turnable” wheels). For example, the base 58 of a scissor lift 50 may have four wheels that can be independently positioned and the wheel position transducer 140, or at least several different wheel position transducers, can detect and account for the wheel position of all of the wheels.

FIG. 5D is a top view of the scissor lift showing one embodiment of a display unit 150 for displaying operation and collision conditions. The display unit 150 may be a screen or monitor that displays various conditions and reports pertaining to the position and status of the lift 50. In one embodiment, the display unit is implemented in conjunction with the user control interface for operating/driving the lift 50. In one embodiment, the display unit 150 includes schematic depictions of the lift 50 that convey the collision status of the lift 50. For example, in one embodiment, the display unit 150 can display highlighted areas of the schematic depiction of the lift 50 that are close to a structure (i.e., within the warning threshold). In other words, the warning indicator may be a highlighted area on the display unit 150 or a flashing/beeping signal emanating from the display unit 150.

In another embodiment, the display unit 150 may display the angle/position of the wheels, thereby allowing an operator to properly orient the wheels before driving the lift 50 to a new location alongside the structure 60. The display unit 150, in conjunction with the user control interface, may include buttons, switches, levers, joysticks, a steering wheel, a throttle, a touch-screen, a keypad, a keyboard, number-pads, etc. The display unit 150 may be mounted to the lift 50 in various positions, according to the specifics of a given application and/or according to the preferences of a specific operator.

FIG. 6A is a schematic block diagram of one embodiment of a controller 200 for avoiding scissor lift collisions. The controller 200 includes a sensing module 210, a collision module 220, a warning module 230, and an over-ride module 240. The sensing module 210 receives conditions and reports from the various sensor sub-systems. Once the conditions are received from the sensors, the collision module 220 determines a collision status for the scissor lift 50. Based on the collision status, the warning module 230 and the over-ride module 240 will determine whether/when to active a warning indicator or an over-ride/shut-off command, respectively. These modules are described in greater detail below with reference to FIG. 6B.

FIG. 6B is a schematic block diagram of another embodiment of the controller 200 for avoiding scissor lift collisions. The controller includes the modules 210, 220, 230, 240 described above, but also shows various sub-modules of the sensing module 210 and a display module 250. The various sub-modules include a basket proximity sub-module 212, a basket contact sub-module 214, a scissor sub-module 216, and a wheel sub-module 218. The basket proximity sub-module 212 detects the spatial proximity of the passenger basket to surrounding objects/structures. The detected spatial proximity may be the shortest distance detected between one face of the passenger basket 52 and a surrounding object/structure. In another embodiment, the spatial proximity detected by the basket proximity sub-module 212 may include a collection of distances, representing a mapping of the objects/structures surrounding the passenger basket 52.

The basket contact sub-module 214 detects an impact condition of the passenger basket with the surrounding objects. For example, the impact condition may simply be a notification that the passenger basket 52 has impacted a surrounding object/structure. In another embodiment, as briefly described above, the impact condition may include the direction and magnitude of the impact.

The scissor sub-module 216 detects an obstruction condition of the scissor extension mechanism with the surrounding objects. The obstruction condition is an indication that the through-beam 134 has been interrupted and that there is an obstruction in the scissor extension mechanism 54. In one embodiment, depending on the number of corresponding sets of emitters and receivers and the distance between adjacent emitters and receivers in the sensor banks, the obstruction condition may further include general dimensions for the obstruction that interrupted the through-beam. The wheel sub-module 218 detects a wheel position of at least one of the wheels 59 of the base 58.

As described above, the collision module 220, according to one embodiment, receives the spatial proximity, the impact condition, the obstruction condition, and the wheel position from the sensing module 210. The collision module 220 then determines a collision status that is based on the various conditions and positions received from the sensing module 210. In one embodiment, the collision status may be an “all-clear” signal, with no impending/detected potential collisions. In another embodiment, the collision status may be a number that represents the distance between the lift 50 and the nearest surrounding object/structure. In yet another embodiment, the collision status may merely be a notification that an obstruction has been detected in the scissor extension mechanism 54. Further, the collision status may be any of the above. In other words, the collision status may be any number, report, or rating that represents the collision situation.

Regardless of whether the collision status, determined from the sensed/detected conditions, is a number, a rating, or a report, the warning module 230 determines if the collision status is within a predetermined warning threshold. If the collision status is within the predetermined warning threshold, the warning module 230 activates a warning indicator to alert/advise the operator accordingly. For example, in one embodiment, the collision status may indicate a distance between the passenger basket 52 and the nearest surrounding object. If that distance is within the predetermined warning threshold, the warning module 230 may activate an audible or visible alarm (i.e., a sound, a light, etc.). For example, for a certain application the warning module 230 may have a warning threshold of 5 feet. If the distance indicated in the collision status is 5 feet or less, a warning indicator is activated.

In one embodiment, the warning module 230 has various warning thresholds with corresponding warning indicators. In other words, if the passenger basket 52 is within a first threshold distance from an object, a first warning indicator may be activated. If the passenger basket 52 continues to move closer to the object (or the object moves closer to the passenger basket 52) so that the basket 52 is within a second threshold distance from the object, a second warning indicator may be activated, alerting the operator of the approaching object.

Similar to the warning module 230, if the collision status is within the over-ride threshold of the over-ride module 240, the over-ride module 240 may limit or halt the operator's control over the lift 50, at least temporarily, to prevent damage to the lift 50 and/or the structure/object that is being repaired and inspected. For example, a collision detected by the basket contact sensor sub-system 120 may generate a collision status that falls within the over-ride threshold and the operator may have limited control over the lift's movement. Thus, the operator may only be able to move the lift in a direction away from the imminent or existing collision in order to prevent or decrease collision damage. In another embodiment, an interruption of the through-beam 134 also causes an over-ride action.

The display module 250 is configured to display various conditions, reports, statuses, etc., to an operator of the lift. In one embodiment, as briefly described above with reference to the display unit 150, the display module may display one or more of the following: the spatial proximity, the impact condition, the obstruction condition, the wheel position, the collision status, the warning indicator, the warning threshold, and the over-ride threshold. For example, the display module 250 may display a schematic depiction of the various conditions and positions of the components of the lift 50. In other words, the display module 250 may highlight an area of the schematic depiction of the lift 50 that is close to a structure (i.e., within the warning threshold). In another embodiment, the display module 250 may display the angle/position of the wheels, thereby allowing an operator to properly orient the wheels before driving the lift 50 to a new location alongside the structure 60.

FIG. 7 is a schematic flowchart diagram of one embodiment of a method 300 for avoiding scissor lift collisions. The method 300 includes at least one of detecting the spatial proximity of the passenger basket to surrounding objects/structures at 310, detecting an impact condition of the passenger basket with the surrounding objects at 320, detecting an obstruction condition of the scissor extension mechanism with the surrounding objects at 330, and detecting a wheel position of at least one of the wheels 59 of the base 58 at 340. The method 300 determines a collision status based on at least one of the spatial proximity, the impact condition, the obstruction condition, and the wheel position at 350. The method 300 further includes determining whether the collision status is within a predetermined warning threshold and activating a warning indicator accordingly at 360. The method 300 also includes determining whether the collision status is within a predetermined over-ride threshold at 370.

In the above description, certain terms may be used such as “up,” “down,” “upper,” “lower,” “horizontal,” “vertical,” “left,” “right,” “over,” “under” and the like. These terms are used, where applicable, to provide some clarity of description when dealing with relative relationships. But, these terms are not intended to imply absolute relationships, positions, and/or orientations. For example, with respect to an object, an “upper” surface can become a “lower” surface simply by turning the object over. Nevertheless, it is still the same object. Further, the terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise. Further, the term “plurality” can be defined as “at least two.”

Additionally, instances in this specification where one element is “coupled” to another element can include direct and indirect coupling. Direct coupling can be defined as one element coupled to and in some contact with another element. Indirect coupling can be defined as coupling between two elements not in direct contact with each other, but having one or more additional elements between the coupled elements. Further, as used herein, securing one element to another element can include direct securing and indirect securing. Additionally, as used herein, “adjacent” does not necessarily denote contact. For example, one element can be adjacent another element without being in contact with that element.

As used herein, the phrase “at least one of”, when used with a list of items, means different combinations of one or more of the listed items may be used and only one of the items in the list may be needed. The item may be a particular object, thing, or category. In other words, “at least one of” means any combination of items or number of items may be used from the list, but not all of the items in the list may be required. For example, “at least one of item A, item B, and item C” may mean item A; item A and item B; item B; item A, item B, and item C; or item B and item C. In some cases, “at least one of item A, item B, and item C” may mean, for example, without limitation, two of item A, one of item B, and ten of item C; four of item B and seven of item C; or some other suitable combination.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of computer readable program code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of computer readable program code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the computer readable program code may be stored and/or propagated on in one or more computer readable medium(s).

The computer readable medium may be a tangible computer readable storage medium storing the computer readable program code. The computer readable storage medium may be, for example, but not limited to, an electronic, magnetic, optical, electromagnetic, infrared, holographic, micromechanical, or semiconductor system, apparatus, or device, or any suitable combination of the foregoing.

More specific examples of the computer readable medium may include but are not limited to a portable computer diskette, a hard disk, a random access memory (RAM), a read-only memory (ROM), an erasable programmable read-only memory (EPROM or Flash memory), a portable compact disc read-only memory (CD-ROM), a digital versatile disc (DVD), an optical storage device, a magnetic storage device, a holographic storage medium, a micromechanical storage device, or any suitable combination of the foregoing. In the context of this document, a computer readable storage medium may be any tangible medium that can contain, and/or store computer readable program code for use by and/or in connection with an instruction execution system, apparatus, or device.

The computer readable medium may also be a computer readable signal medium. A computer readable signal medium may include a propagated data signal with computer readable program code embodied therein, for example, in baseband or as part of a carrier wave. Such a propagated signal may take any of a variety of forms, including, but not limited to, electrical, electro-magnetic, magnetic, optical, or any suitable combination thereof. A computer readable signal medium may be any computer readable medium that is not a computer readable storage medium and that can communicate, propagate, or transport computer readable program code for use by or in connection with an instruction execution system, apparatus, or device. Computer readable program code embodied on a computer readable signal medium may be transmitted using any appropriate medium, including but not limited to wireless, wireline, optical fiber cable, Radio Frequency (RF), or the like, or any suitable combination of the foregoing.

In one embodiment, the computer readable medium may comprise a combination of one or more computer readable storage mediums and one or more computer readable signal mediums. For example, computer readable program code may be both propagated as an electro-magnetic signal through a fiber optic cable for execution by a processor and stored on RAM storage device for execution by the processor.

Computer readable program code for carrying out operations for aspects of the present invention may be written in any combination of one or more programming languages, including an object oriented programming language such as Java, Smalltalk, C++ or the like and conventional procedural programming languages, such as the “C” programming language or similar programming languages (e.g., LabVIEW). The computer readable program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

The present subject matter may be embodied in other specific forms without departing from its spirit or essential characteristics. The described embodiments are to be considered in all respects only as illustrative and not restrictive. All changes which come within the meaning and range of equivalency of the claims are to be embraced within their scope.

What is claimed is:

1-20. (canceled)

21. A method for avoiding collisions between a scissor lift and surrounding objects, the scissor lift comprising a passenger basket, the method comprising:
providing padded bumpers coupled to the passenger basket, wherein impact sensor elements are embedded within the padded bumpers;
detecting an impact condition of the passenger basket with respect to the surrounding objects by receiving impact information from the impact sensor elements;
determining a collision status based on the impact condition; and
activating a warning indicator when the collision status is within a predetermined warning threshold.

22. The method of claim 21, further comprising displaying at least one of the impact information, the impact condition, and the collision status.

23. The method of claim 21, further comprising over-riding operator control of the scissor lift when the collision status is within a predetermined over-ride threshold.

24. A controller apparatus for a scissor lift, the scissor lift comprising a passenger basket, the controller apparatus comprising:
a sensing module comprising a basket contact sub-module that detects an impact condition of the passenger basket with the surrounding objects by receiving impact information from impact sensor elements embedded within padded bumpers coupled to the passenger basket;
a collision module that determines a collision status based on the impact condition; and
a warning module that activates a warning indicator when the collision status is within a predetermined warning threshold.

25. The controller apparatus of claim 24, wherein the passenger basket comprises an extendable platform, and wherein impact sensor elements are disposed on the extendable platform.

26. The controller apparatus of claim 24, wherein the impact sensor elements comprise omni-directional sensors, and wherein the impact condition comprises directional force of the impact.

27. The controller apparatus of claim 24, further comprising an over-ride module that over-rides control of the scissor lift when the collision status is within a predetermined over-ride threshold.

28. The controller apparatus of claim 27, further comprising a display module that displays one or more of the impact condition, the collision status, the warning indicator, the warning threshold, and the over-ride threshold.

29. The controller apparatus of claim 27, wherein the warning module comprises multiple warning thresholds that correspond with multiple warning indicators.

30. A collision avoidance system for a scissor lift, the scissor lift comprising a passenger basket, the collision avoidance system comprising a basket contact sensor sub-system comprising impact sensor elements embedded within padded bumpers coupled to the passenger basket.

31. The collision avoidance system of claim 30, wherein the padded bumpers are coupled to the passenger basket along edges of the passenger basket.

32. The collision avoidance system of claim 30, wherein the padded bumpers are coupled to faces of the passenger basket.

33. The collision avoidance system of claim 30, wherein the impact sensor elements comprise omni-directional sensors.

34. The collision avoidance system of claim 33, wherein the impact sensor elements detect a direction of the impact.

35. The collision avoidance system of claim 31, wherein the passenger basket comprises an extendable platform, and wherein impact sensor elements are disposed on the extendable platform.

36. The collision avoidance system of claim 35, wherein the extendable platform comprises padded bumpers and the impact sensor elements are embedded within the padded bumpers of the extendable platform.

37. The collision avoidance system of claim 31, wherein:
the scissor lift further comprises a scissor extension mechanism and a base with wheels; and
the collision avoidance system further comprises a through-beam sensor sub-system mounted to the scissor extension mechanism, the scissor extension mechanism comprising a basket-end portion and a base-end portion, the through-beam sensor sub-system comprising at least one corresponding set of an emitter and a receiver, wherein the emitter of each corresponding set is mounted to one of the basket-end portion and the base-end portion and the receiver of each corresponding set is mounted to the other of the basket-end portion and the base-end portion.

38. The collision avoidance system of claim 37, wherein the at least one corresponding set of the emitter and the receiver of the through-beam sensor sub-system utilizes infrared light.

39. The collision avoidance system of claim 37, wherein the scissor extension mechanism comprises exterior nodes, the at least one corresponding set of the emitter and the receiver being moveable with the exterior nodes along with the basket-end portion and the base-end portion of the scissor extension mechanism.

40. The collision avoidance system of claim 37, wherein the through-beam sensor sub-system comprises three corresponding sets of the emitter and the receiver, and wherein the three corresponding sets of the emitter and the receiver substantially form a sensor curtain.
